(19) United States
(12) Patent Application Publication
(10) Pub. No.: US 2018/0339372 A1
(43) Pub. Date: Nov. 29, 2018

(54) SOLDER ALLOY AND SOLDER COMPOSITION

(71) Applicant: Taiwan Green Point Enterprises Co., Ltd., Taichung City (TW)

(72) Inventor: Che-Cheng Chang, Taichung City (TW)

(73) Assignee: Taiwan Green Point Enterprises Co., Ltd., Taichung City (TW)

(21) Appl. No.: 15/983,960

(22) Filed: May 18, 2018

(30) Foreign Application Priority Data
May 25, 2017 (TW) 106117314

(51) Int. Cl. B23K 35/26; C22C 12/00; C22C 30/04

(52) U.S. Cl. CPC B23K 35/264; C22C 30/04; C22C 12/00; B23K 35/26

(57) ABSTRACT

A solder alloy includes 18 wt % to 28 wt % of indium, 44.5 wt % to 54.5 wt % of bismuth, greater than 0 wt % and not more than 1.45 wt % of zirconium, and the balance being tin, based on 100 wt % of the solder alloy.

### CROSS REFERENCE TO RELATED APPLICATION

This application claims priority of Taiwanese Patent Application No. 106117314, filed on May 25, 2017, which is incorporated by reference as if fully set forth.

### FIELD OF INVENTION

The disclosure relates to a solder alloy and a solder composition, and more particularly to a solder alloy with a low melting point and a solder composition with a low melting point and capable of forming intermetallic compounds (IMCs).

### BACKGROUND

Plastic materials have the advantages of being lightweight and easily shaped, and have been widely applied in various fields. As the technology for forming conductive circuits on surfaces of plastic objects becomes well developed, this in turn creates a need of soldering electronic components on the surfaces of plastic objects.

Due to the low melting point of some plastic materials, solder alloys used to solder the electronic components on the plastic objects need to have a relatively lower melting point. Moreover, in certain circumstances, after soldering, the solder joints thus formed need to withstand relatively higher temperatures in subsequent processes. For example, the soldering process is performed at lower than 130° C., while the solder joints may need to withstand a temperature exceeding 200° C. in subsequent processes. Therefore, apart from the low melting point requirement, there is a need for the solder alloy to withstand relatively higher temperatures after formation of the solder joints.

### SUMMARY

Therefore, an object of the disclosure is to provide a solder alloy and a solder composition that can alleviate at least one of the drawbacks of the prior art.

According to one aspect of the disclosure, a solder alloy includes 18 wt % to 28 wt % of indium, 44.5 wt % to 54.5 wt % of bismuth, greater than 0 wt % and not more than 1.45 wt % of zirconium, and the balance being tin, based on 100 wt % of the solder alloy.

According to another aspect of the disclosure, a solder composition includes 0 wt % to 10 wt % of copper, 0 wt % to 10 wt % of silver, 0 wt % to 10 wt % of nickel, 0 wt % to 10 wt % of tin, 10 wt % to 15 wt % of flux and the balance being the aforementioned solder alloy, based on 100 wt % of the solder composition, with the proviso that the copper, silver, nickel and tin are not 0 wt % simultaneously.

### BRIEF DESCRIPTION OF THE DRAWINGS

Other features and advantages of the present disclosure will become apparent in the following detailed description of the embodiment with reference to the accompanying drawings, of which:

FIGS. 1 and 2 are scanning electron microscope (SEM) photographs showing an embodiment of a solder alloy of the present disclosure for soldering a substrate (Au/Ni/Cu board) to an electronic component (chip);

FIG. 3 shows three SEM photographs of the solder alloy of the present disclosure which was prepared in a powder form;

FIGS. 4 to 8 are charge-coupled device(CCD) image photographs taken in a simulated reflow furnace illustrating real-time formation of a solder joint during soldering; and

FIG. 9 is a field emission electron microscopy photograph illustrating an analysis of the solder joint formed by soldering a solder composition of the present disclosure and the substrate.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it should be clearly understood that the word “comprising” means “including but not limited to”, and that the word “comprise” has a corresponding meaning.

Unless otherwise defined, all technical and scientific terms used herein have the meaning as commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

According to the disclosure, a solder alloy includes 18 wt % to 28 wt % of indium, 44.5 wt % to 54.5 wt % of bismuth, greater than 0 wt % and not more than 1.45 wt % of zirconium, and the balance being tin based on 100 wt % of the solder alloy.

In certain embodiments, the zirconium of the solder alloy is present in an amount ranging from 0.01 wt % to 1.45 wt % based on 100 wt % of the solder alloy. In an exemplary embodiment, the zirconium of the solder alloy is present in an amount of about 0.5 wt % based on 100 wt % of the solder alloy.

In certain embodiments, the solder alloy has a melting point ranging between 56° C. and 130° C.

According to the disclosure, a solder composition includes 0 wt % to 10 wt % of copper, 0 wt % to 10 wt % of silver, 0 wt % to 10 wt % of nickel, 0 wt % to 10 wt % of tin, 10 wt % to 15 wt % of flux and the balance being the solder alloy as mentioned above, based on 100 wt % of the solder composition. The amount of copper, silver, nickel and tin of the solder composition are not 0 wt % simultaneously. In other words, the solder composition may include at least one of copper, silver, nickel and tin.

Examples of flux suitable for use in this disclosure include, but are not limited to, rosins, esters, alcohols, etc., and combinations thereof.

The disclosure will be further described by way of the following examples. However, it should be understood that the following examples are solely intended for the purpose of illustration and should not be construed as limiting the disclosure in practice.

### Examples

Preparation of Solder Alloy

A solder alloy of each Examples 1 to 7 (E1-E7) of this disclosure includes four metal elements, including bismuth (Bi), indium (In), tin (Sn) and zirconium (Zr). In contrast, the solder alloy of Comparative Example 1 (CE1) only includes Bi, In and Sn (without Zr). The amounts of the respective metal element in each example of the solder alloy are summarized in Table 1.

The procedure for preparing each example of the solder alloy in a total weight of 10 g involves the following steps. Each of the required metal elements (in a form of metal ball) was placed in a quartz tube. The quartz tube was vacuum-sealed with a hydrogen and oxygen flame, and then heated in a furnace at 800° C. for one hour to melt these metal elements. Afterwards, the furnace was cooled to 300° C. by opening the furnace's door for about an hour. The quartz tube was then soaked in water for heat-quenching, thereby forming the solder alloy serving as a test sample. Finally, the quartz tube was broken to take the test sample out.

Measurements of Melting Point and Hardness

The melting point of the test sample of the solder alloy (10 mg) is determined using a differential scanning calorimetry (DSC) analyzer (TA Instruments Ltd.; Model: MDSC2920). The operation temperature for the DSC analyzer was set between 40° C. and 250° C., with a temperature-increasing rate of 10° C./min.

The hardness of the solder alloy is determined using a Micro Vickers Hardness tester (Akashi Corporation; Model: MVK-H11). Specifically, each test sample was pressed using 10 g of load for 10 seconds. Each test sample was pressed five times at five different points (P1-P5), thereby obtaining the hardness of each point and the average hardness of the five points (P1-P5).

TABLE 1

| | | | | | Melting range |
|---|---|---|---|---|---|
| | Bi (wt %) | In (wt %) | Sn (wt %) | Zr (wt %) | (° C.) |
| E1 | 49.5 | 23 | 27 | 0.5 | 56-67, 81-94 |
| E2 | 49.5 | 28 | 22 | 0.5 | 56-67, 80-113 |
| E3 | 49.5 | 18 | 32 | 0.5 | 56-66, 80-121 |
| E4 | 44.5 | 28 | 27 | 0.5 | 56-67, 79-109 |
| E5 | 54.5 | 18 | 27 | 0.5 | 55-68, 80-112 |
| E6 | 49.99 | 23 | 27 | 0.01 | 56-98 |
| E7 | 48.55 | 23 | 27 | 1.45 | 56-98 |
| CE1 | 50 | 23 | 27 | 0 | 84-98 |

Table 1 shows the metal elements and the melting point of each test sample of E1 to E7 and CE1. As shown in Table 1, the melting point of each test sample of E1 to E7 and CE1 ranged between 55° C. and 121° C.

These results demonstrated that addition of zirconium in the solder alloy may lower the solidus temperature (at which the melting begins) of the solder alloy. In addition, zirconium that is present in an amount of 0.5 wt % based on 100 wt % of the solder alloy, may also increase the liquidus temperature (at which the melting is completed) of the solder alloy, thereby enabling each of the test samples of E1 to E5 to withstand higher temperatures for subsequent processes after soldering.

TABLE 2

| | | | | | | | | Percentage |
|---|---|---|---|---|---|---|---|---|
| | Zr | | | | | | Aver- | of increased |
| | (wt %) | P1 | P2 | P3 | P4 | P5 | age | hardness |
| E1 | 0.5 | 14.6 | 14.1 | 13.8 | 14.3 | 14.5 | 14.26 | 20.64% |
| E6 | 0.01 | 11.8 | 13.1 | 13.2 | 12.9 | 13.3 | 12.86 | 8.8% |
| E7 | 1.45 | 13.5 | 12.9 | 13.2 | 12.8 | 14.0 | 13.28 | 12.35% |
| CE1 | 0 | 11.7 | 12.9 | 11.1 | 11.3 | 12.1 | 11.82 | — |

Table 2 shows the hardness of each test sample of E1, E6, E7 and CE1. As shown in Table 2, the hardness of E1, E6 and E7 respectively increased by 20.64%, 8.8% and 12.35% as compared to CE1, indicating that adding a proper amount of zirconium to the solder alloy can increase the hardness of the formed solder joints.

Microscopic Examination

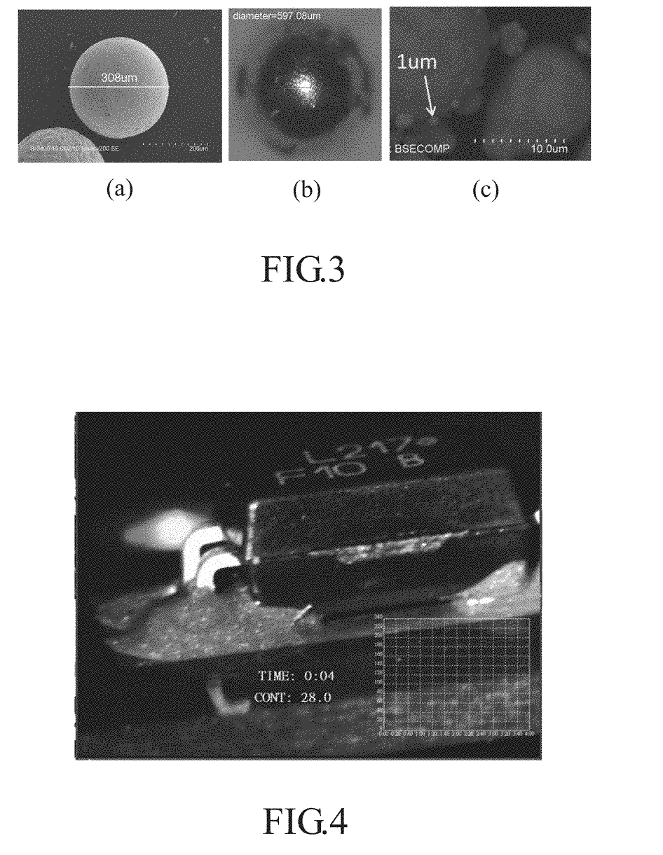

Scanning electron microscope (SEM) (Hitachi High-Technologies Corporation; Model: S3400) was applied to observe the test samples of E6 and CE1. The results show that the crystallite size of E6 was about 3 μm to 4 μm, whereas the crystallite size of CE1 was about 6 μm to 9 μm, demonstrating that the addition of an appropriate amount of zirconium to the solder alloy can achieve the effect of grain refinement. The solder alloy of the present disclosure may be made into a powder form having a particle size of 1 to 1000 μm, as shown in FIG. 3.

For analyzing the brazing effect, the test sample of E1 was used to solder an electronic component (chip) to a substrate coated with Aurum/Nickel/Copper (Au/Ni/Cu) multi-metal layers. The soldering process was carried out in a simulated reflow furnace (Malcomtech International, Inc.; Model: SRS-1C), with a set temperature of up to 130° C., allowing the electronic components to be soldered to the substrate so as to form a soldered product.

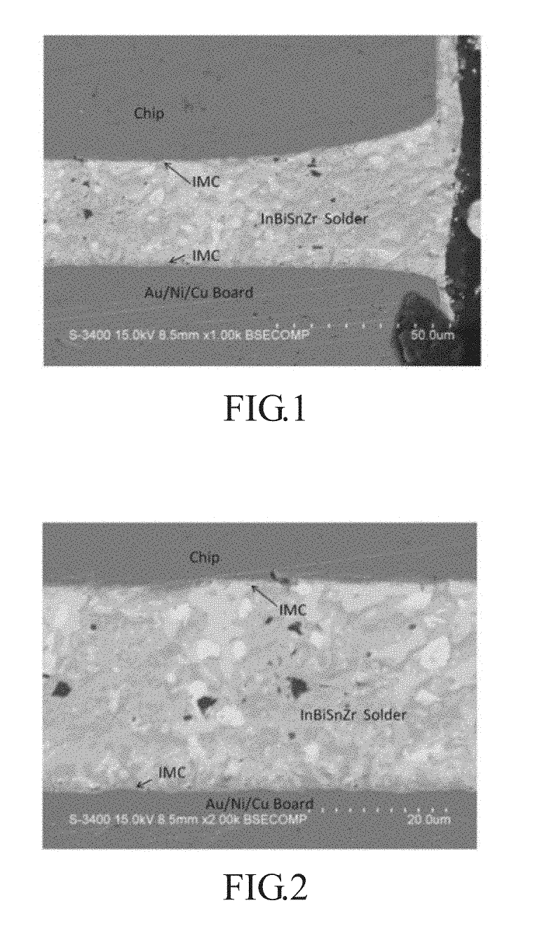

From the SEM photographs of the obtained soldered product shown in FIGS. 1 and 2, it can be seen that the test sample of E 1 can effectively solder the electronic component to the substrate. Moreover, intermetallic compounds (IMCs) were seen in the SEM photographs. The resultant product has an excellent quality without forming holes therein.

Based on the aforementioned experimental results, the applicant inferred that, with addition of zirconium, the solder alloy can begin melting at a lower temperature and provide the effect of grain refinement, thereby improving the mechanical properties of the solder alloy (such as hardness value, fatigue resistance and creep resistance), and avoiding the formation of holes in the soldered product.

Preparation of Solder Composition

The solder alloy of this disclosure can be mixed with other metal elements capable of forming intermetallic compounds (IMCs) with the solder alloy, such as copper, silver, nickel and tin (the particle size thereof may range from 1 to 1000 μm). Examples of the IMCs in this disclosure may include, but are not limited to, ZrSn2, Ag2In, Ag3In, CuSn, NiSn, etc. The resultant mixture can be further added with a flux to form a solder composition, which may be used for Surface Mount Technology (SMT) process.

To be specific, the solder composition of Application Example 1 (AE1), which serves as a solder paste, was prepared by mixing, based on 100 wt % of the solder composition, 50 wt % of the solder alloy of E1 obtained above (in a form of alloy ball), 10 wt % of copper powder, 10 wt % of nickel powder, 10 wt % of silver powder, 10 wt % of tin powder and 10 wt % of flux.

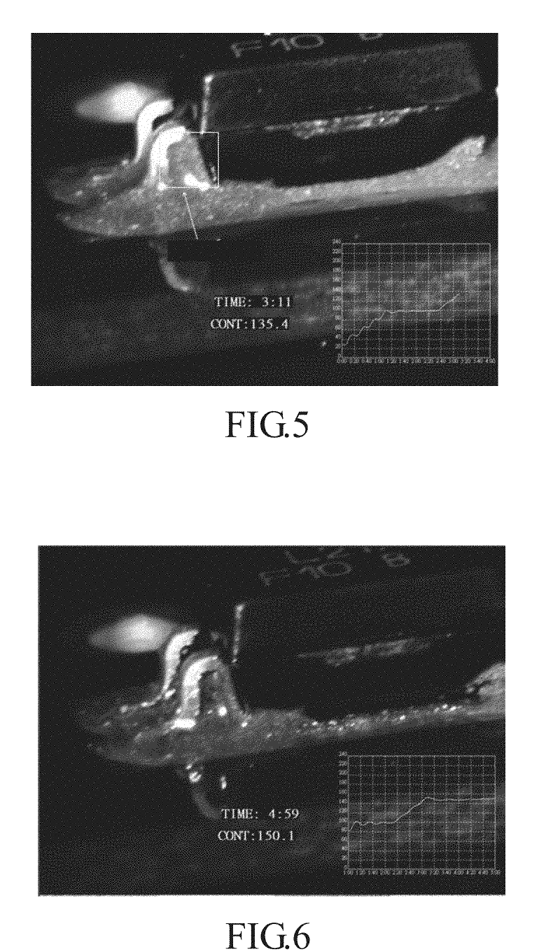

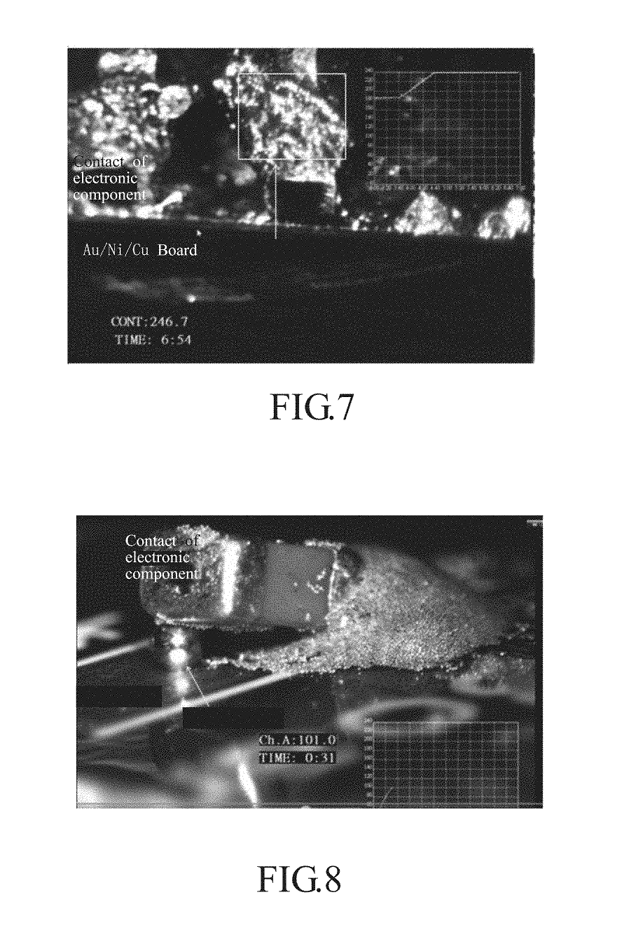

The solder composition was applied to a substrate coated with Au/Ni/Cu multi-metal layers, then placed into a simulated reflow furnace equipped with a charge-coupled device (CCD) for observing the soldering conditions under different heating temperatures. FIG. 4 is a CCD image photographs showing real-time formation of a solder joint during soldering in a simulated reflow furnace. The photographs in FIGS. 5 and 6 showed that when the temperatures of the furnace were respectively set at 135° C. and 150° C. (i.e., the first time soldering), the solder composition of AE1 was in a molten state, and a solder joint was formed on the substrate. After solidifying, the solder joint was heated in the furnace to a temperature that exceeds 250° C. for the second time soldering, and melting of the solder joint was not observed (see boxed region of FIG. 7).

Furthermore, a solder composition of Comparative Application Example 1 (CAE1), which was prepared by mixing 50 wt % to 99 wt % of the solder alloy of E1 obtained above (in a form of alloy ball) and 1 wt % to 10 wt % of the flux (i.e., without copper, nickel, silver and tin powders added thereto), was also subjected to the same observation in the simulated reflow furnace for comparison purpose. For the first time soldering at the temperature between 135° C. to 150° C., the solder composition of CAE1 may form a solder joint on the substrate. However, the solder joint became melted after the second time soldering, when the temperature in the furnace exceeded 130° C. (shown by an arrow in FIG. 8).

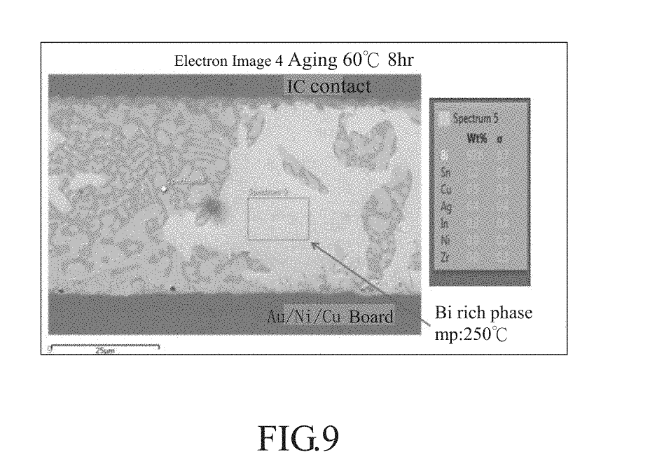

Addition of one of the metal powders (such as copper, nickel, silver and tin) that may form IMCs with the solder alloy of this disclosure could enhance the reliability and heat resistance of the solder joints thus formed. In addition, for demonstrating the existence of IMCs, the substrate applied with the solder composition of AE1 was soldered in the simulated reflow furnace at a maximum temperature of 150° C. for 5 to 8 minutes, followed by aging at 60° C. for 8 hours. The obtained product was analyzed with a field emission electron microscope (Hitachi High-Technologies Corporation; Model: S3400). As shown in FIG. 9, a large amount of IMCs (such as Ag₃In) and a continuous Bi rich phase were formed in most areas of the thus formed solder joints of the product after soldering, thereby increasing the melting point of the solder joints.

In summary, addition of zirconium lowers the melting point of the solder alloy and improves hardness of the solder alloy. In addition, the solder alloy can be further combined with one of the added metals (such as copper, nickel, silver and tin) to form the solder composition. The resultant solder composition can form IMCs with the metals of the substrate to be soldered at the soldering interface of the substrate. The solder alloy of the composition may also form IMCs with the added metals in the thus formed soldered joints. Therefore, most areas of the solder joints may be composed of a large amount of IMCs, thereby being capable to withstand high temperature with enhanced reliability.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A solder alloy, comprising: 18 wt % to 28 wt % of indium, 44.5 wt % to 54.5 wt % of bismuth, greater than 0 wt % and not more than 1.45 wt % of zirconium, and the balance being tin, based on 100 wt % of said solder alloy.

2. The solder alloy as claimed in claim 1, wherein said zirconium is present in an amount ranging from 0.01 wt % to 1.45 wt % based on 100 wt % of said solder alloy.

3. The solder alloy as claimed in claim 2, wherein said zirconium is present in an amount of 0.5 wt % based on 100 wt % of said solder alloy.

4. The solder alloy as claimed in claim 1, which has a melting point ranging between 55° C. and 130° C.

5. A solder composition, comprising: 0 wt % to 10 wt % of copper, 0 wt % to 10 wt % of silver, 0 wt % to 10 wt % of nickel, 0 wt % to 10 wt % of tin, 10 wt % to 15 wt % of flux and the balance being a solder alloy of claim 1, based on 100 wt % of said solder composition, with the proviso that said copper, silver, nickel and tin are not 0 wt % simultaneously.

6. The solder composition as claimed in claim 5, wherein said solder alloy includes zirconium in an amount ranging from 0.01 wt % to 1.45 wt % based on 100 wt % of said solder alloy.

7. The solder composition as claimed in claim 6, wherein said zirconium is present in an amount of 0.5 wt % based on 100 wt % of said solder alloy.

8. The solder composition as claimed in claim 5, wherein said solder alloy has a melting point ranging between 55° C. and 130° C.
